(19) United States
(12) Patent Application Publication
(10) Pub. No.: US 2004/0177459 A1
(43) Pub. Date: Sep. 16, 2004

(54) Cleaning apparatus with optional decorative indicia

(76) Inventor: William D. McKay, Grand Blanc, MI (US)

Correspondence Address: WILLIAM M HANLON, JR, YOUNG & BASILE, PC, 3001 WEST BIG BEAVER ROAD, SUITE 624, TROY, MI, 48084-3107, US

(21) Appl. No.: 10/812,475

(22) Filed: Mar. 30, 2004

Related U.S. Application Data
(63) Continuation-in-part of application No. 10/329,717, filed on Dec. 26, 2002.
(63) Continuation-in-part of application No. 10/302,038, filed on Nov. 22, 2002, now Pat. No. 6,763,977.
Application No. 10/302,038 is a continuation-in-part of application No. 10/143,396, filed on May 10, 2002, now Pat. No. 6,698,626.
(60) Provisional application No. 60/426,589, filed on Nov. 15, 2002.

(51) Int. Cl. A47L 25/08; B25G 1/00

(52) U.S. Cl. 15/104.002; 15/143.1; 16/110.1; 16/111.1

(57) ABSTRACT

A cleaning apparatus includes a one piece, blow-molded body supporting a debris or dirt removing material, such as a tubular, adhesive lint remover roller and/or a stationary directional lint brush fabric. The body includes a unitary handle and roller support. In one aspect, the handle is formed of a transparent material such that one or more labels, each carrying decorative indicia may be viewed through the handle for a decorative effect. An insert defining decorative indicia may be inserted into the handle to provide a decorative effect by itself or in combination with decorative indicia on one or both of the exteriorly mounted labels.

### CROSS REFERENCE TO CO-PENDING APPLICATIONS

This application is a continuation-in-part of copending application Ser. No. 10/329,717, filed Dec. 16, 2002, which claims the benefit of the priority filing date of U.S. Provisional Application Serial No. 60/426,589, filed Nov. 15, 2002, and which is also a continuation-in-part of co-pending U.S. application Ser. No. 10/302,038, filed Nov. 22, 2002, which is a continuation-in-part of U.S. patent application Ser. No. 10/143,396, filed May 10, 2002, now U.S. Pat. No. 6,698,626, the contents of all of which are incorporated herein in their entirety.

### BACKGROUND

The present invention relates to cleaning apparatus for removing debris or dirt from surfaces and more particularly to lint roller assemblies.

There are many previously known lint roller assemblies. These previously known lint roller assemblies typically comprise a handle secured to a cylindrical lint roller support. A tubular cylindrical adhesive lint roller is then removably mounted to the support such that the adhesive roller is rotatively relative to the handle. In use, the adhesive lint roller is rolled along a surface to remove unsightly particles, lint, pet hair, etc.

The previously known lint roller assemblies have used a number of different options to rotatively secure the lint roller support to the handle. For example, in U.S. Pat. No. 4,361,923, the lint roller support and handle are separately constructed and then rotatively secured together. One disadvantage of this type of previously known lint roller assembly, however, is that the rotatively connection between the handle and lint roller support is subject to mechanical failure. Another drawback is that a directional lint fabric cannot be attached to the rotatable support section and still be operable. It rotates with the support and is not stationary to provide for brushing motion.

A further disadvantage to this type of assembly is that both the lint roller support and the handle are separately molded from plastic and then assembled together requiring two separate molds, one for each part.

Still other types of lint roller assemblies, such as that disclosed in U.S. Pat. No. 6,055,695, the lint roller handle includes a pair of elongated housing parts, which are substantially identical to each other. A disadvantage to this type of assembly is that each housing part must be snapped exactly into the other perfectly registering using pins and sockets. A further disadvantage is that the handle section being integral to the support section is manufactured with rigid plastic material and uncomfortable to grip and does not provide for a customized plastic decorative top or hanger.

Still other types of previously known lint roller assemblies, such as that disclosed in U.S. Pat. No. 4,5577,0111, utilize a unitary lint roller handle and lint roller support. These previously known lint roller assemblies, however, require a complex and, therefore, expensive mold design in order to mold the lint roller handle and support. Furthermore, a relatively large frictional engagement between the lint roller and the lint roller support often times interferes with the desired free rotation of the lint roller about the lint roller support.

### SUMMARY

The present invention is a cleaning apparatus which addresses the abovementioned disadvantages of the previously known art.

In one aspect, the cleaning apparatus of the present invention is a unitarily formed lint roller assembly including an adhesive tape roll engaging a hollow support body or cylinder having a one piece, molded handle extending from one end as a unitary, one piece blow-molded body.

A plurality of radially extending, adhesive tape roll sleeve engaging fingers or elements are provided along the outer end of the hollow support cylinder in and registry with an annular stop flange selectively retain the adhesive tape roll sleeve assembly therebetween while permitting rotative movement of the assembly on the support cylinder.

The outer surface of the hollow support cylinder is selectively provided with at least two spaced apart annular bearing ridges which are adapted to slidingly engage the inner surface of the adhesive tape roll mounted on the hollow support cylinder so as to facilitate relative selective rotative movement of the sleeve assembly with respect thereto.

The integral handle extending axially outwardly from one end thereof is optionally connected to a cap in a frictional snap fit, threaded attachment, etc.

In still another aspect of the present invention, the hollow support section is oval in shape to accept to strips of directional lint brush fabric; one on the front and the other on the backside.

In another aspect of the invention, at least the handle of the one piece blow-molded assembly is formed of a transparent material. One or more labels and/or an optional insert into the interior of the handle are provided with decorative indicia, such as designs, print, etc., which are visible exteriorly of the handle to provide an aesthetic effect to the present cleaning apparatus. One of the labels may be transparent so as to enable the decorative indicia thereon to be visible from the other side of the handle. One of the labels may also have an opaque backing with decorative indicia on the backing disposed against the exterior surface of the handle so as to be visible through from the opposite side of the handle through the handle. The decorative insert is disposed within the interior of the handle and is visible from one or other side of the handle. The decorative insert includes means for fixing the insert in an axial position within the handle.

One or more of the labels and the decorative insert may be combined to provide a combination decorative design visible through the handle. The decorative insert may also be in the form of a two or three dimensional figurine which is attached by a stem to the cap so as to appear to be suspended within the handle or can be a loose figure inserted into the interior of the handle prior to attachment of the cap.

The apparatus of the present invention provides a less expensive manufacturing cost than prior lint roller apparatus along with additional functionality and aesthetic appearance.

### BRIEF DESCRIPTION OF THE DRAWING

The various features, advantages and other uses of the present invention will become more apparent by referring to the following detailed description and drawing in which:

FIG. 1 is a front elevational view of one aspect of a cleaning apparatus of the present invention;

FIG. 2 is a side elevational view of the apparatus shown in FIG. 1;

FIG. 3 is an exploded view of a cap for an alternate handle;

FIG. 4 is a cross-sectional view of the assembled cap and handle of FIG. 3;

FIGS. 5-9 are front elevational views of the handle of the cleaning apparatus shown with decorative labels and internal inserts;

FIG. 10 is a longitudinal, partial cross-sectional view of the handle of the present apparatus showing another aspect of a decorative insert according to the present invention; and

FIG. 11 is a longitudinal, partial cross-sectional view of the handle of the present apparatus showing yet another aspect of a decorative insert according to the present invention.

### DETAILED DESCRIPTION

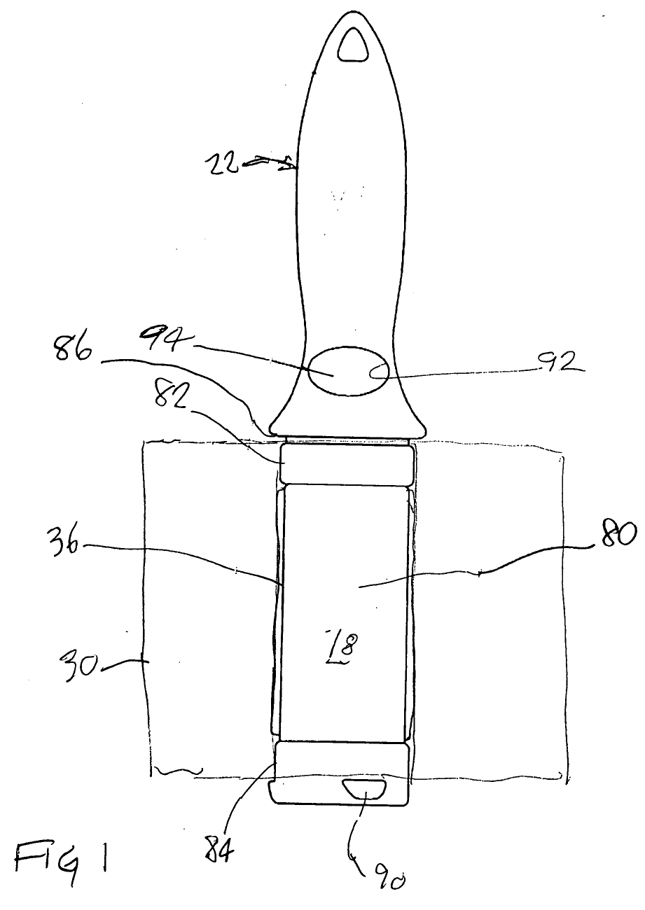

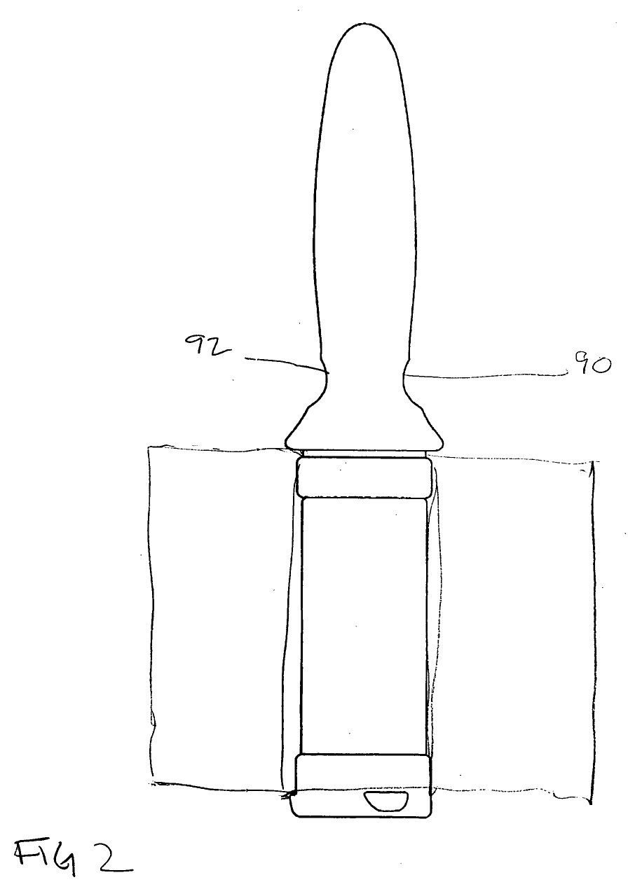

Referring now to FIGS. 1 and 2, there is depicted a cleaning apparatus 10 constructed in accordance with the teachings of one aspect of the present invention.

The apparatus 10 includes a unitary, one piece molded plastic body 12 which includes a handle 22 and cleaning element, support 18.

In this aspect of the invention, the apparatus 10 includes a one-piece body which can be formed of a blow molded plastic.

The handle 22 integrally transitions into a cleaning element support section 78 which has an inner elongated generally cylindrical portion 80 for supporting an optional directional fabric cloth layer 36. Enlarged diameter bearing surfaces 82 and 84 are disposed on opposite ends of the inner portion 80 and have a larger diameter for rotatably supporting a tape roll 30 thereover, with an inner diameter of the tape roll 30 spaced from the directional fabric 36. The bearing surface 82 is disposed adjacent to an enlarged shoulder 86 which acts as a stop edge for one end of the tape roll 30.

The opposite end of the support section 78, axially adjacent to the bearing surface 84 is formed with a plurality of radially outward extending fingers or projections 90. The fingers 90 expand the tape roll 30 upon insertion of a tape roll 30 thereover to enable the tape roll 30 to be slid over the support section 78 into engagement with the bearing surfaces 82 and 84. The fingers 90 trap the tape roll 30 on the support section 78.

In use, the tape roll 30, which may be any commercially available tape roll having outwardly facing adhesive sheets or strips, generally arranged in a plurality of sheets wound in a roll wherein the outermost sheets are peelable from the roll, one at a time, along perforated edges of each sheet, is forced over the enlarged diameter of the ends of the fingers 90 causing the fingers 90 to optionally bend radially inward to allow passage of the inner surface of the roll 30 or the inner surface of a core in the roll 30, if a core is employed, over the ends of the fingers 90.

Alternately, the fingers 90 maybe a single, continuous bead or plurality of circumferentially spaced beads which are non-compressible but which momentarily deform the roll 30 to permit passage of the roll 30 over the bead or beads.

As shown in FIG. 2, when the roll 30 is completely mounted on the support 18, it may freely rotate under applied force to remove lint, pet hair, and other debris from surfaces, such as clothes, furniture, or other fabrics. Easier rotation of the roll 30 maybe achieved by use of longitudinally extending spaced ribs on the bearing surfaces 82 and 84 which minimize frictional contact with the inner surface of the roll 30.

At the same time, the outermost dimension of the diametrically opposed ends of the fingers 90 is greater than the inner diameter of the roll 30 thereby enabling the fingers 90 to retain the roll 30 on the tape support section 18.

At any time, the roll 30 may be removed by forcing it over the ends of the fingers 90 thereby exposing the directional fabric 36 for use. The tape roll 30 may then be reapplied as necessary to the tape support 18 as described above.

The fabric 36 is, by example, a dimensional woven nylon pile velvet created by cutting intertwined yard threads. The pile surface is heat set in a specific direction to provide directional uniformity. This enable the fabric 36 to be drawn in one direction across a surface to be cleaned to pickup lint, pet hair, and other debris from the surface. Dragging the fabric 36 in an opposite direction across another surface removes any collected lint and debris from the fabric 36.

The section of directional fabric may be wound and frictionally or adhesively joined to the tape support 18. Alternately, the directional fabric 36 may comprise multiple sections each adhesively adhered to the exterior of the tape support 18.

The hollow support section 18 may have an oblate or oval shape to accept strips of directional fabric, one on one side and one on an opposed side. Even though the tape support 18 may have an oblate shape, the first and second bearing surfaces 32 and 34 should be substantially circular to allow easy rotation of a tape roll 30 thereover with minimal frictional engagement.

The handle 22 has opposed indentations 90 and 92 with a generally oval shape, by example only. The indentations 90 and 92 provide a convenient location for a label 94 as well as for positioning of the user's thumb during use of the cleaning apparatus 10.

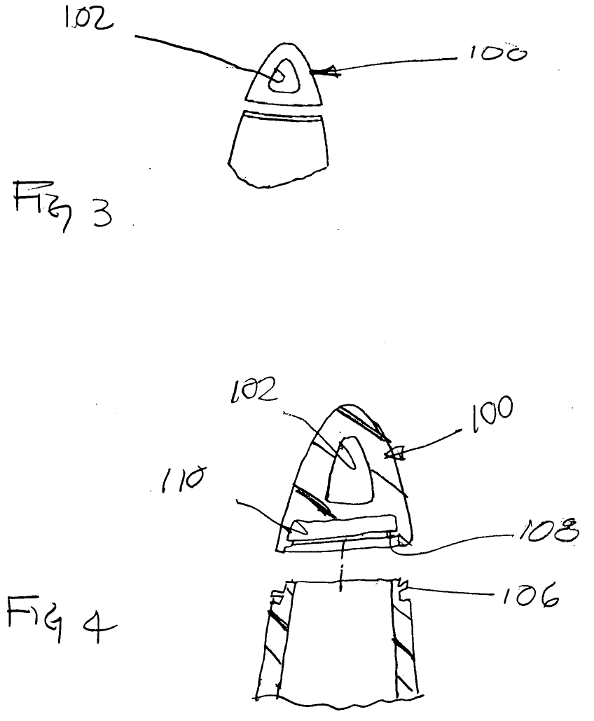

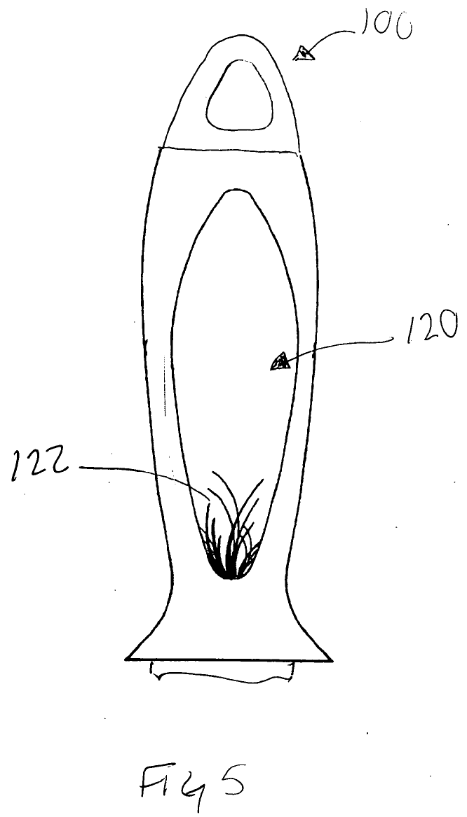

As shown in FIGS. 3 and 4, the cleaning apparatus 10 may include an optional cap 100 which can be a solid body or optionally can include an aperture 102 for decoration as well as to permit the cleaning apparatus 10 to be hung on a display rack for sale as well as to be hung hook between uses by the user.

The cap 100 may be fixedly or releasably attached to the handle 22. Preferably, the cap 100, by example only, is releasably attached to the handle 22 by interconnecting means, such as mating threads 106 on the handle 22 and threads 108 in an end bore 110 extending from one end of the cap 100.

Alternately, the cap 100 may be attached to the end of the handle 22 by means of snap connections, such as one or more legs extending from one end of the cap 100 which engage complimentary-shaped recesses or notches in the end of the handle 22.

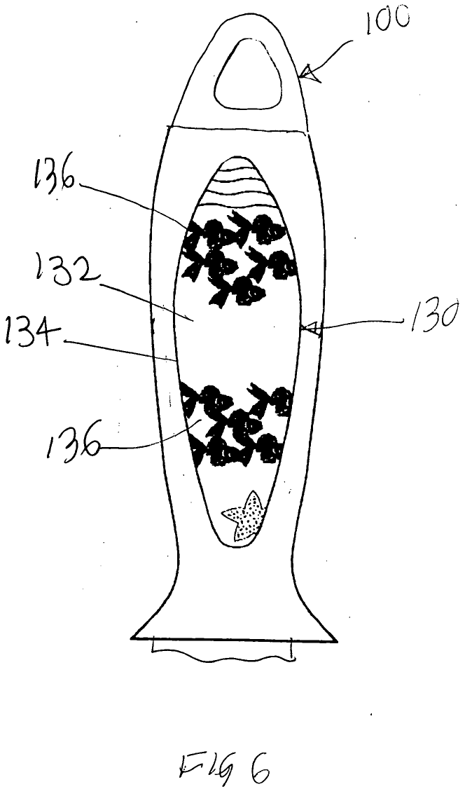

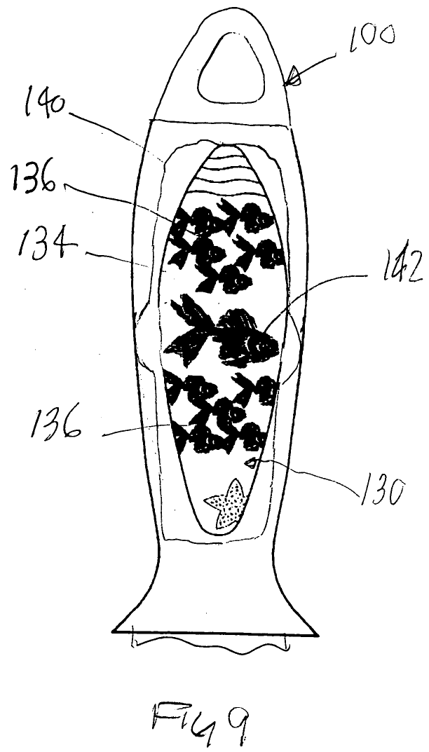

Referring now to FIGS. 5-9, there is depicted another aspect of the present invention in which the handle is used with external decals or labels attached to the exterior surface of the handle 22 and decorative interiorly disposed inserts which can be used separately or in combination to provide a decorative effect. It will be understood that the handle 22, although constructed in the manner described above and shown in FIGS. 1-4, with or without the optional cap 100 as a one piece blow-molded extension of the support, may be constructed in other configurations, such as a two-part handle and support which are fixedly secured together by adhesive, snaps, etc. It will also be understood that the handle can be a one piece handle without the separately attachable cap 100. Likewise, the support may have other configurations, such as a cage or spindle rotatably affixed to the handle.

As shown in FIG. 5, a first decorative label or decal 120 is applied by adhesive to an exterior surface of the handle 22. The label 120 is preferably formed of a transparent material, such as a transparent film, and has decorative indicia 122 applied thereto. Since the label 120 is transparent as is the handle 22 which is formed of clear PVC, PETE, polypropylene, etc. The decorative indicia 120 on the label 120 may be easily viewed through the handle 22.

Referring now to FIG. 6, a decorative decal or label 130 is mounted on one exterior surface of the handle 22. The label 130, in this aspect of the invention, has an opaque background 132 and is applied, such as by adhesive, to the handle 22 such that a rear surface 134 is in contact with the handle 22. The rear surface 134 has decorative indicia 136 applied thereto. Since the handle 22 is transparent, the decorative indicia 136 may be viewed through the handle 22.

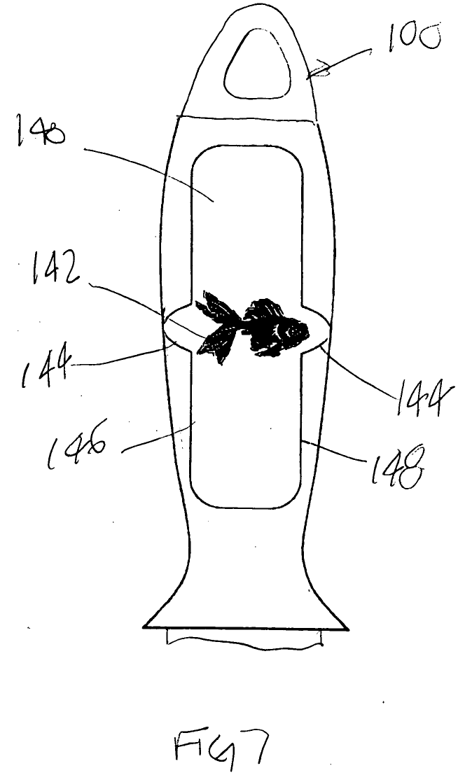

A decorative insert 140 is depicted in FIG. 7. The insert 140 is formed of a flexible material, such as an opaque or transparent plastic sheet. The insert 140 also has decorative indicia 142 applied thereto. The decorative insert 140 is preferably flexible to enable it to be bent into a smaller diameter for insertion through the open end of the handle 22 18 which can then be closed by the cap 100.

The insert 140 also has fixing means 144, such as opposed projections extending laterally outward from the opposed sides 146 and 148 of the insert 140. The fixing means or projections 144 engage the interior surface of the handle 22 to fixedly position the insert 140 in a desired longitudinal position within the handle 22. Alternately, the fixing means may be provided by selecting the width of the insert 140 such that the opposed sides 146 and 148 of the insert 140 engage an interior surface of the handle 22 to longitudinally position the insert 140 in the desired longitudinal position in the handle 22. The fixing means provides a fixed engagement of the insert 140 to prevent movement of the insert 140 in the handle 22 after the insert 140 is fixed in position.

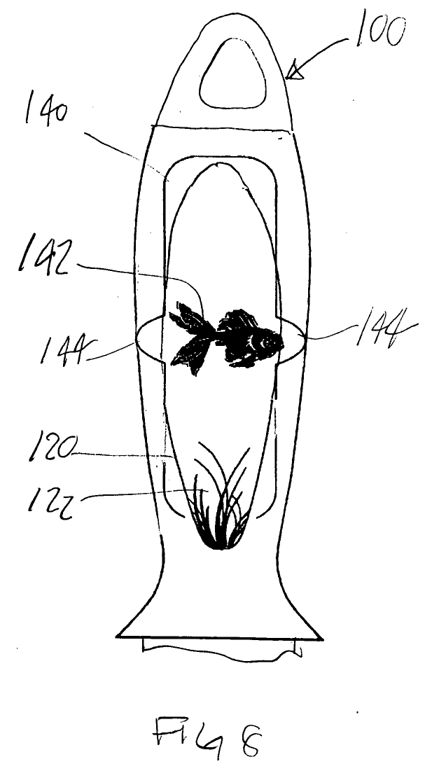

As shown in FIG. 8, the first transparent label 120 may be combined with the transparent insert 140 to provide a combination decorative effect which includes the overlaid indicia 142 on the insert 140 and the indicia 122 on the label 120. This decorative effect can be viewed from either side of the handle 22.

It is also possible to combine the label 120 with the label 130 to provide an overlaid decorative effect formed of the indicia 136 on the label 130 and the indicia 122 on the label 120. Similarly, the labels 120 and 130 may be combined with the insert 140 to provide a combination of the decorative indicia 122, 136 and 142 viewable from one side of the handle.

Similarly, the insert 140 may be combined with the label 130 to provide an overlaid combined decorative effect of the indicia 142 on the transparent insert 140 and the decorative indicia 136 on the rear surface 134 of the label 130. This combined decorative effect is viewable from only one side of the handle.

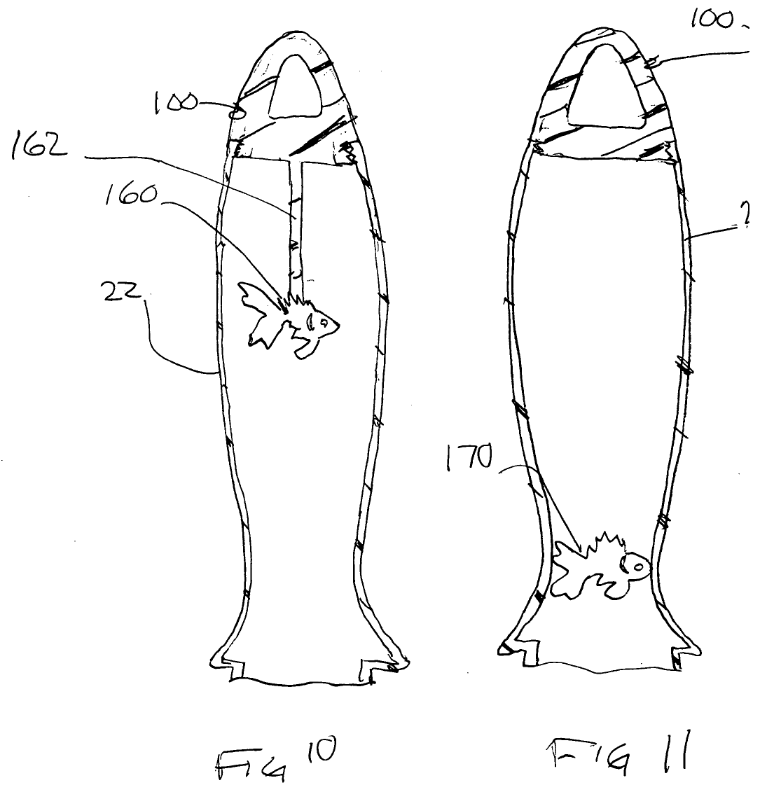

Referring now to FIG. 10, there is depicted another aspect of a decorative insert 160 according to the present invention. In this aspect, the decorative insert 160 is in the form of a two or preferably, a three dimensional figurine depicting an animal, human, bird, geometric design, etc. The insert 160 is carried with the cap 100, such as by an elongated, small diameter, thin stem 162 attached to or integrally molded as part of the cap 100.

In this aspect, the decorative insert 160 may be integrally molded with the stem 162 and the cap 100 or attached to the stem 162 by adhesive, mechanical fasteners, etc. In use, the decorative insert 160 appears to hang or float within the interior of the handle 22.

In FIG. 11, a decorative insert 170, similar to the decorative insert 160 and in the form of a two or three dimensional body, is provided as a loose or separate member which is inserted into the handle 22 prior to attachment of the cap 100 to the handle 22. The insert 170 may be dimensioned to move freely throughout the handle 22 or, may be designed with suitable dimensions to engage the narrow diameter portion of the handle 22 and remain in a fixed location throughout use of the cleaning apparatus.

In summary, there has been a cleaning apparatus which is useful in efficiently removing dirt, debris, embedded hair, from fabrics and other surfaces. The apparatus is formed as a single one piece apparatus for a low manufacturing cost. The apparatus may also include a decorative insert which can be viewed through the handle when the handle is formed of a transparent material.

What is claimed is:

1. A cleaning apparatus comprising:
a one piece blow-molded body having a unitary handle and a support for receiving a debris removing member;
the handle having an open end opposite from the support; and
a cap mounted on and closing the open end of the handle.

2. to the apparatus of claim 1 wherein the support further comprises:
first and second spaced bearing surfaces adapted to support a rotatable tape roll about the support.

3. The apparatus of claim 2 further comprising:
means, carried on the support, for capturing the tape roll on the support.

4. The apparatus of claim 3 wherein the capturing means comprises:
a plurality of circumferentially spaced projections formed on one end of the support.

5. The cleaning apparatus of claim 1 wherein:
the particle removing material is a wound substrate having an adhesive outer surface.

6. The apparatus of claim 1 further comprising:
an aperture formed in the handle.

7. The apparatus of claim 1 wherein:
the cap is removably mounted on the handle.

8. The apparatus of claim 7 wherein:
the cap is threadingly mounted on the handle.

9. The apparatus of claim 1 wherein the handle is formed of a transparent material.

10. The apparatus of claim 9 further comprising:
a label mounted on the handle, the label carrying decorative indicia visible through the handle.

11. The apparatus of claim 10 wherein the label comprises:
an opaque sheet having decorative indicia on a surface contacting the handle, the decorative indicia visible through the handle.

12. The apparatus of claim 10 wherein the label further comprises:
a transparent sheet having decorative indicia viewable through the handle.

13. The apparatus of claim 9 further comprising:
an insert mountable in the handle, the insert carrying decorative indicia visible through the handle.

14. The apparatus of claim 13 further comprising:
a label mounted on the handle, the label carrying decorative indicia visible through the handle; and
the decorative indicia on the insert and the decorative indicia on the label forming an overlaid combined decorative indicia visible through the handle.

15. The apparatus of claim 13 wherein the insert further comprises:
means, carried on the insert, for fixedly positioning the insert within the handle.

16. The apparatus of claim 13 wherein:
the insert is formed of a flexible material to enable the insert to be inserted through an open end of the handle.

17. The apparatus of claim 13 wherein:
the insert is a decorative body carried with the cap and disposed within the handle when the cap is mounted on the end of the handle.

18. The apparatus of claim 17 further comprising:
a stem depending from the cap, the decorative insert carried on the stem.

19. The apparatus of claim 13 wherein the insert comprises:
a three dimensional decorative body loosely disposed within the handle.

20. The cleaning apparatus comprising:
a body including a handle and a support, the support receiving a cleaning member;
a handle formed of a transparent material; and
a member carrying decorative indicia carried on the handle, with the decorative indicia visible through the handle.

21. The apparatus of claim 20 wherein the decorative member comprises:
a label mounted on the handle, the label carrying decorative indicia visible through the handle.

22. The apparatus of claim 21 wherein the label comprises:
an opaque sheet having decorative indicia on a surface contacting the handle, the decorative indicia visible through the handle.

23. The apparatus of claim 21 wherein the label further comprises:
a transparent sheet having decorative indicia viewable through the handle.

24. The apparatus of claim 20 further comprising:
an insert mountable in the handle, the insert carrying decorative indicia visible through the handle.

25. The apparatus of claim 24 further comprising:
a label mounted on the handle, the label carrying decorative indicia visible through the handle; and
the decorative indicia on the insert and the decorative indicia on the label forming an overlaid combined decorative indicia visible through the handle.

26. The apparatus of claim 24 wherein the insert further comprises:
means, carried on the insert, for fixedly positioning the insert within the handle.

27. The apparatus of claim 24 wherein:
the insert is formed of a flexible material to enable the insert to be inserted through an open end of the handle.

28. The apparatus of claim 24 wherein:
the insert is a decorative body carried with the cap and disposed within the handle when the cap is mounted on the end of the handle.

29. The apparatus of claim 28 further comprising:
a stem depending from the cap, the decorative insert carried on the stem.

30. The apparatus of claim 24 wherein the insert comprises:
a three dimensional decorative body loosely disposed within the handle.
